(19) United States
(12) Patent Application Publication
(10) Pub. No.: US 2019/0086298 A1
(43) Pub. Date: Mar. 21, 2019

(54) BLACK SAND MAGNET WITH POCKET CLIP

(71) Applicant: Siya, Inc, Santa Fe Springs, CA (US)

(72) Inventor: Sudhir Mundhra, Santa Fe Springs, CA (US)

(21) Appl. No.: 15/709,243

(22) Filed: Sep. 19, 2017

(51) Int. Cl. G01N 1/08

(52) U.S. Cl. CPC G01N 1/08

(57) ABSTRACT

A device for black sand collection having a two-piece housing holding a rod with a magnet at an end thereof. A button and coil allow the rod to be depressed such that the magnet is pushed toward an end of the device, allowing the device to magnetically collect black sand. Releasing the button allows the device to release the black sand.

### TECHNICAL FIELD

The present invention relates generally to the field of materials collection, and more specifically relates to a device for black sand collection having a movable magnet, wherein the device is configured to removably retain black sand.

### BACKGROUND OF THE INVENTION

Prospecting for valuable minerals is not only an enjoyable activity, it is also potentially lucrative. As such, prospectors seek to identify and mine sites that are likely to contain valuable minerals. One way to identify such a site is to find black sand. The presence of black sand generally signifies that the area contains valuable minerals. Additionally, black sand itself often contains valuable minerals as well.

The term “black sand” generally refers to two types of black granular materials. The first type of black sand is a granular basalt deposit left after a volcanic eruption, such as generally comprise the black sand beaches found around the world. The second type of black sand, and the type of interest to prospectors, is a heavy, glossy, and partly magnetic mixture of (usually) fine sands that is generally found as part of a placer deposit. A placer deposit, or a “placer,” is an accumulation of valuable minerals formed by gravity separation during sedimentary processes over long periods of time. When a placer is found in a river or stream, it is called an alluvial placer. Placers, and the black sand within them, sometimes contain gold. Hence, when a prospector finds black sand, the prospector desires to separate and collect the black sand, then identify and obtain any gold that may be mixed in or bound to the black sand.

Most handheld black sand and gold collection techniques involve a pan that the prospector swirls to mechanically separate the desired minerals from undesired sediment. Because these techniques sift and separate mixtures by size of granular element, such techniques are inherently limited. For example, these techniques fail to exploit black sand's magnetic properties. What is needed, therefore, is a compact, lightweight, and hand-held black sand collector that magnetically collects black sand. With such a device, a user could use a traditional-type pan to collect a certain amount of material, then use the device to collect any black sand and deposit the black sand into a vial. Or, in certain environments, a user could use the device independently of a pan.

Various attempts to improve black sand collection have been made. One such attempt can be seen with respect to U.S. Pat. No. 9,358,550, incorporated by reference in its entirety herein, which generally discloses a magnetized drill bit device. When caused to rotate by a drill, this disclosure's drill bit magnet draws and retains the magnetized black sand and spins out the undesired materials. While this disclosure does provide for a magnetized, and hence more efficient, method of separating and retaining black sand, this disclosure requires use of a drill and may be inconvenient for many prospectors in the field. Additionally, by spinning the rest of the sand and other materials at a high rate, such particles can go flying uncontrollably. Therefore, not only would this disclosure create a mess, it could be dangerous to the user and those around the user.

Another attempt can be seen with respect to U.S. Pat. No. 8,240,775, incorporated by reference in its entirety herein, which generally discloses a hand-held apparatus for collecting particulate deposits in a stream (alluvial) placer. This device generally depicts a tubular sluice box of sorts, wherein a cylindrical member contains the riffle tray. While this disclosure does have the advantage of being light and portable, and of posing little danger to others, it relies on the classic riffle tray design rather than utilizing more efficient magnetism techniques. Additionally, this disclosure cannot be used apart from a flowing body of water.

Yet another attempt can be seen with respect to U.S. Pat. No. 2,073,122, incorporated by reference in its entirety herein, which generally discloses a submergible cylindrical placer mining device that utilizes the Venturi effect to create suction on a hose-like attachment, thus enabling the hose-like attachment to draw up sediment from an alluvial placer. While this disclosure does provide for a cylindrical and easily portable device, and while it does present a certain amount of automation to the task, it fails to provide for magnetic entrapment of black sands.

Thus, a need exists for a new device for black sand collection that uses magnetism to collect and separate black sand.

### SUMMARY OF THE INVENTION

The present disclosure is directed to a black sand magnet with pocket clip that in some embodiments may comprise a device for black sand collection that provides for the entrapment and selective release of black sand, in addition to other properties.

Certain aspects, advantages, and novel features have been described and may be summarized in whole or in part in the present disclosure. Not all of the present invention's advantages may be achieved in accordance with any one particular embodiment. Hence, the disclosed subject matter may be embodied or carried out in a manner that achieves or optimizes one advantage or group of advantages without achieving all advantages as may be taught or suggested.

In certain embodiments, the device comprises a handheld device comprising, by way of illustration and not limitation, a barrel, a housing, a cover, a magnet, a metal rod, a coil, a button, and a pocket clip. In some embodiments, the device may be generally cylindrical, the magnet may be attached to the metal rod, the metal rod may be connected to the coil, the coil may be connected to the button, and the barrel and housing may be substantially hollow. In some embodiments, when a user pushes down on the button, the coil may compress and may drive the metal rod through the housing and the barrel, pushing the magnet through the housing and the barrel and exposing the magnet. The magnet may be configured to removably retain black sand. Thus, when exposed, the magnet may removably extract black sand from a mixture and removably retain the black sand. When the user wishes to release the black sand, the user may release the button, which may cause the coil and rod to retreat, which may in turn cause the black sand to dislodge from the magnet.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

These and other features, aspects and advantages of the present invention will become better understood with regard to the following description, appended claims, and accompanying figures where:

FIG. 1A shows a perspective view of a device for black sand collection in accordance with an embodiment of the invention;

FIG. 1B shows a side view of a device for black sand collection in accordance with one embodiment of the invention;

FIG. 1C shows a side view of a device for black sand collection in accordance with one embodiment of the invention;

FIG. 1D shows a side view of a device for black sand collection in accordance with one embodiment of the invention;

FIG. 2A shows a perspective view of a device for black sand collection in accordance with an embodiment of the invention with a piece of the housing removed;

FIGS. 2B and 2C shows a side view of a device for black sand collection in accordance with an embodiment of the invention with a piece of the housing removed.

### DETAILED DESCRIPTION OF THE INVENTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

As used in this disclosure, except where the context requires otherwise, the term “comprise” and variations of the term, such as “comprising”, “comprises” and “comprised” are not intended to exclude other additives, components, integers or steps. Additionally, in the following description, specific details are given to provide a thorough understanding of the embodiments. However, it will be understood by one of ordinary skill in the art that the embodiments may be practiced without these specific details. Well-known features, elements or techniques may not be shown in detail in order not to obscure the embodiments.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements. As will be understood by those with skill in the art, the actual dimensions and proportions of any embodiment or element of an embodiment disclosed in this disclosure will be determined by its intended use.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

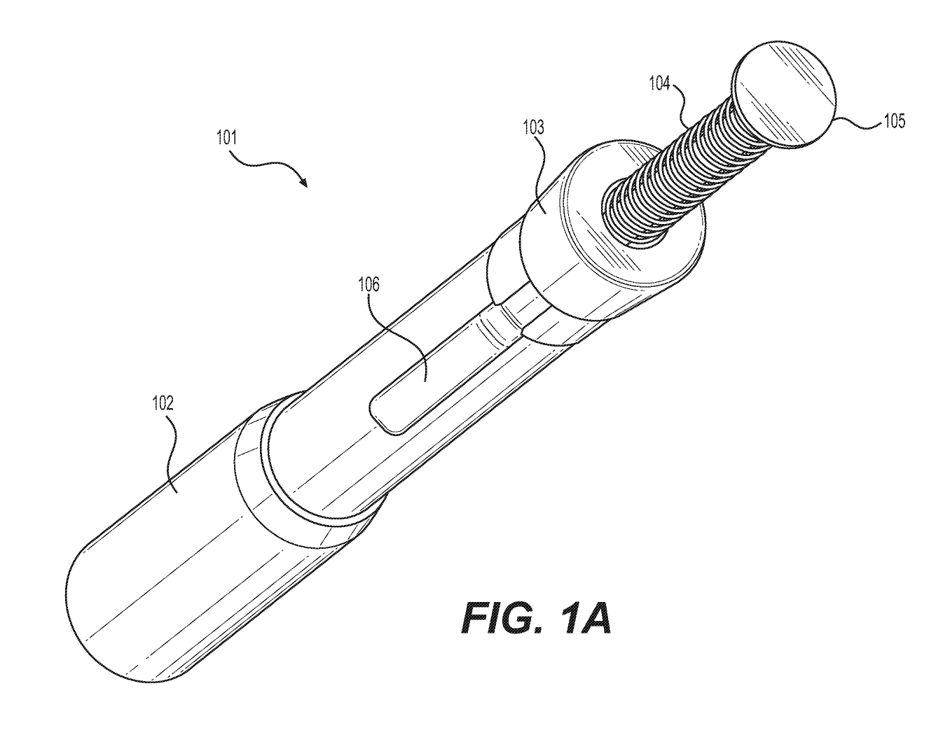

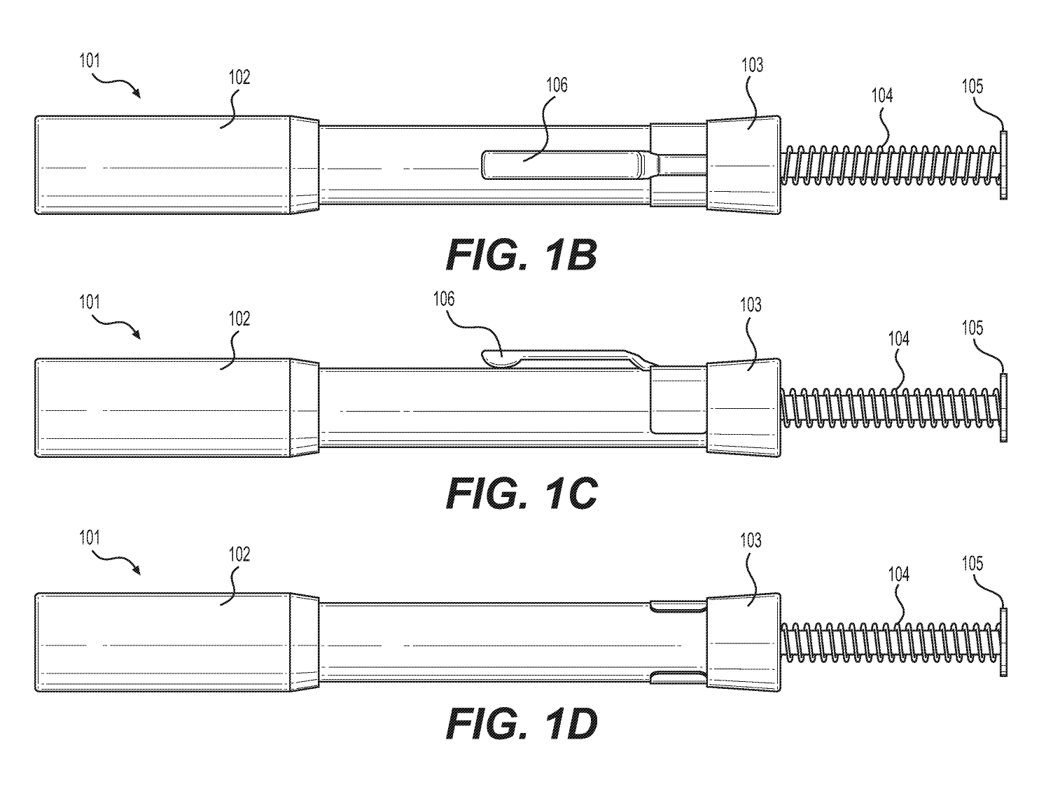

FIG. 1A shows a bottom perspective view of a device for black sand collection in accordance with an embodiment of the invention, wherein one or more embodiments of black sand magnet with pocket clip 101 may comprise barrel 102, cover 103, coil 104, button 105, pocket clip 106, and housing 107.

In some embodiments, barrel 102 may be configured as a substantially hollow cylinder having a cavity at both ends. Additionally, in some embodiments, housing 107 may be configured as a substantially hollow cylinder.

Coil 104 may be metal, or in some embodiments may be comprised of any material known in the art to compress and expand sufficient to carry out one or more objects of the present invention. Such materials may be, by way of illustration and not limitation, a plastic, an elastomer, a wood, a metal alloy, or any combination of any material known in the art to compress and expand sufficient to carry out one or more objects of the present invention.

As well, cover 103 is contemplated, in some embodiments, to be composed of plastic. However, cover 103 may be comprised of any material known in the art, such as a ceramic, a wood, a metal, a metal alloy, or any material known in the art to have properties sufficient to carry out one or more objects of the present invention. Cover 103 may be shaped so as to define a center cavity allowing metal rod 202 to pass through, while also having a sufficient upper surface so as to provide a force point for coil 104 to compress against.

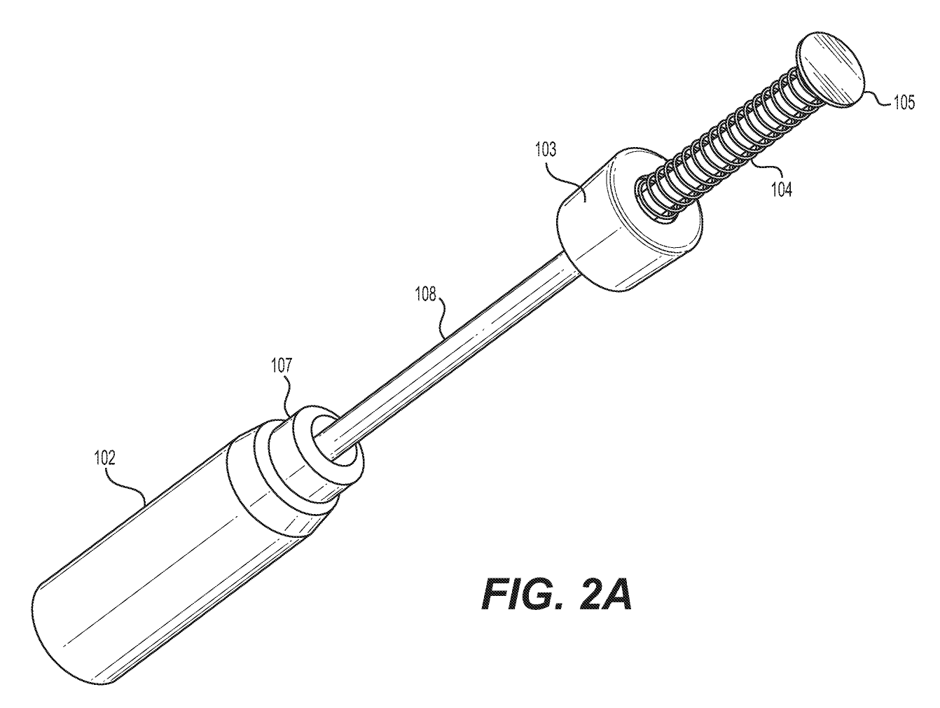

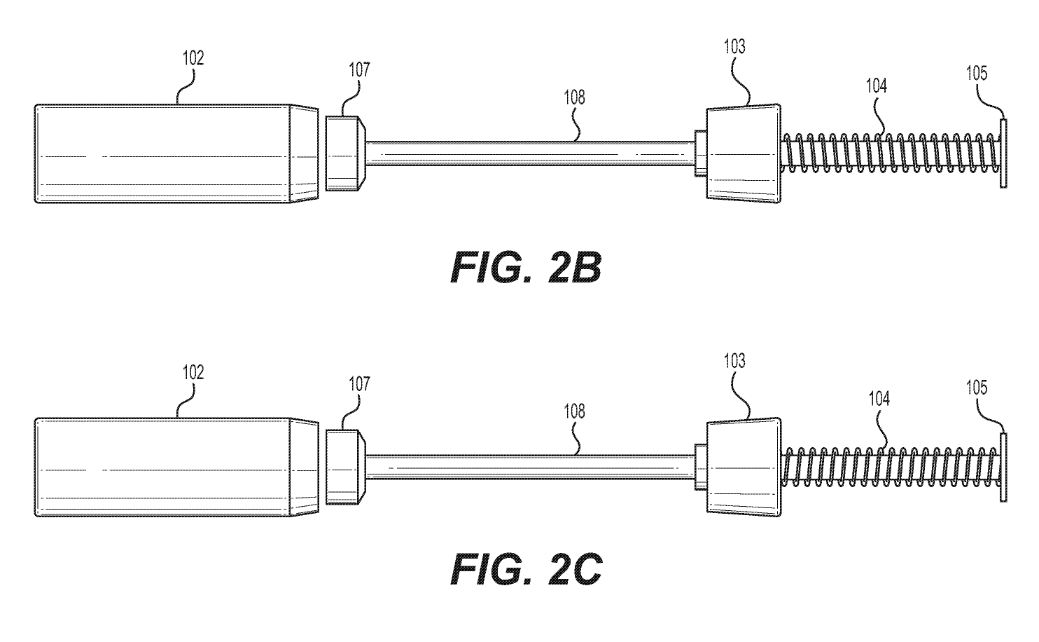

As can be seen in FIG. 1A, button 105, in some embodiments, may be configured as a flat disc suitable for manipulation by a finger or thumb. It is consequently contemplated that in some embodiments, a user may grasp the present invention around the barrel 102, the housing 107, or both, with the fingers of one hand and, when desired, press down with the user's thumb of the same hand upon button 105, thus compressing coil 104. As can be seen in FIG. 2A, FIG. 2B and FIG. 2C, in some embodiments, compressing the coil may cause metal rod 202 to move through housing 107 and barrel 102, consequently also moving magnet 201 in the same direction (away from button 105).

FIG. 1B shows a top plan view of a device for black sand collection in accordance with one embodiment of the invention, wherein one or more embodiments of black sand magnet with pocket clip 101 may comprise barrel 102, cover 103, coil 104, button 105, pocket clip 106, and housing 107.

FIG. 1C shows an elevational view a device for black sand collection in accordance with one embodiment of the invention, wherein one or more embodiments of black sand magnet with pocket clip 101 may comprise barrel 102, cover 103, coil 104, button 105, pocket clip 106, and housing 107.

FIG. 1D shows a bottom plan view a device for black sand collection in accordance with one embodiment of the invention, wherein one or more embodiments of black sand magnet with pocket clip 101 may comprise barrel 102, cover 103, coil 104, button 105, and housing 107.

FIG. 2A shows a bottom perspective view of a device for black sand collection in accordance with an embodiment of the invention, wherein one or more embodiments of black sand magnet with pocket clip 101 may comprise magnet 201 and metal rod 202, along with barrel 102, cover 103, coil 104, and button 105.

The embodiment shown in FIG. 2A may represent the present invention, in some embodiments, depicted as having housing 107 removed for purposes of clarity. In various embodiments, the present invention may comprise a device for black sand collection having a fixed housing 107, a removable housing 107, or an embodiment lacking housing 107.

FIG. 2B shows a top plan view of a device for black sand collection in accordance with an embodiment of the invention, wherein one or more embodiments of black sand magnet with pocket clip 101 may comprise barrel 102, cover 103, coil 104, button 105, magnet 201, and metal rod 202.

In some embodiments, the present invention may be provided as a kit or a disassembled unit. Whether provided assembled or as a kit, the embodiment depicted in FIG. 2B discloses an embodiment wherein barrel 102 disconnected from magnet 201 and the rest of the present invention. Because, in some embodiments, barrel 102 may be configured as a hollow cylinder, it is contemplated that in some embodiments magnet 202 and associated portions of metal rod 201 may pass through barrel 102 when button 105 is pressed.

FIG. 2C shows a bottom plan view of a device for black sand collection in accordance with an embodiment of the invention, wherein one or more embodiments of black sand magnet with pocket clip 101 may comprise magnet 201 and metal rod 202, along with barrel 102, cover 103, coil 104, button 105, and pocket clip 106. FIG. 2C also shows an embodiment wherein barrel 102 is disconnected from the rest of the present invention, also by way of illustration and not limitation.

The drawings and associated descriptions provided herein are intended to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

What is claimed is:

1. A device for black sand collection, comprising:
a two-piece housing comprising a fixed-housing a removable barrel,
a cover formed at one end of said removable barrel;
a pocket clip formed on said removable barrel;
a rod extending through said two-piece housing;
said rod having a magnet formed at one end thereof;
a coil formed on the other end of said rod, outside of said two-piece housing;
a button formed at a distal end of said rod adjacent to said coil;
wherein when the button is depressed, the magnet is pushed to an end of said fixed-housing such that black sand may be magnetically collected.
